(19) United States
(12) Patent Application Publication
(10) Pub. No.: US 2004/0177661 A1
(43) Pub. Date: Sep. 16, 2004

(54) Antitheft locking assembly for a motorbike

(75) Inventor: Bozidar Klinsic, Cranebrook (AU)

Correspondence Address: SPECKMAN LAW GROUP PLLC, 1501 WESTERN AVE, SEATTLE, WA, 98101, US

(73) Assignee: Bozidar KLINISIC and Ivana KLINISIC, Cranebrook (AU)

(21) Appl. No.: 10/389,427

(22) Filed: Mar. 14, 2003

(51) Int. Cl. B62H 5/00; E05B 71/00

(52) U.S. Cl. 70/234

(57) ABSTRACT

An antitheft locking assembly (10) for a motorbike is anchored to the ground (13) or other immobile anchorage, and locks over the motorbike in a manner that prevents theft of the motorbike.

The antitheft locking assembly (10) has first post means (12) adapted to be anchored to the ground (13) and second post means (18) spaced apart from the first post means (12). The second post means (18) comprises a mounting post member (20) adapted to be mounted securably into the ground (13) and a locking post member (22) adapted to be lockably engaged to the mounting post member (20) and extend upwardly therefrom. Rail means (24) adjustably interconnect the first post means (12) and the locking post member (22) and is movable between a first position where the rail means (24) allows access of the motorbike to and from a parked location in a space between the first post means (12) and the second post means (18), and a second position where the rail means (24) obstructs access of the motorbike to and from the parked location. The rail means (24) is lockably secured in its second position over the motorbike So as to prevent the theft of the motorbike.

### FIELD OF THE INVENTION

The present invention relates to an antitheft locking assembly for a motorbike.

### BACKGROUND OF THE INVENTION

The theft of motorbikes, especially expensive or much sought after motorbikes, is not an uncommon occurrence from public parking spaces, or even occasionally from private property, such as driveways and garages. Inbuilt wheel locking devices and bracket clamps may not provide the necessary deterrent against the committed thief who is likely to remove the axle bolt of the front wheel from the wheel forks, thus freeing the remainder of the motorbike from the still locked front wheel. It is also likely that a thief may simply lift and remove the entire motorbike from its parked position, where the wheel is not anchored to the ground or other immobile anchoring means.

Where the motorbike is chained to say, a ground anchored rack, a thief may cut the chain or, if the chain cannot by cut and is secured through the front wheel, remove the remainder of the bike from the front wheel by tampering with the front wheel axle bolt as described above.

There is, therefore, a need for an antitheft locking assembly for a 20 motorbike that is tamper proof and which prevents the entire motorbike from being lifted and removed from its parked position.

### SUMMARY OF THE INVENTION

Accordingly, it is an object of the present invention to provide an antitheft locking assembly for a motorbike in which the assembly is anchored to the ground or other immobile anchoring medium, and in which the assembly locks over the motorbike in a manner that prevents theft of the motorbike.

According to the present invention, there is provided an antitheft locking assembly for a motorbike comprising first post means adapted to be anchored to the ground or other immobile anchoring medium, second post mean spaced apart from the first post means, the second post means comprising a mounting post member adapted to be mounted securably into the ground and a locking post member adapted to be lockably engaged to the mounting post member and extend upwardly therefrom, rail means adjustably interconnecting the first post means and the locking post member and being movable between a first position where it allows access of the motorbike to and from a parked location in a space between the first post means and the second post means, and a second position where it obstructs a access of the motorbike to and from the said parked location, the rail means being lockably secured in its second position over the motorbike so as to prevent the theft of the motorbike.

Preferably, the rail means has a first end that is pivotally connected to the first post means.

It is preferred that the locking post member has a lock opening, and the rail means has a second end that is adapted to be received within the lock opening.

The lock opening of the locking post member preferably extends downwardly from its summit, and the second end of the rail means projects downwardly so as to be received within the lock opening when the rail means pivots into its second position where it can be lockably secured.

Preferably, the locking post member has a longitudinal axis about which it is adapted to be rotated with respect to the mounting post member.

It is preferred that the rail means is lockably secured when in its second position by rotating the locking post member about its longitudinal axis.

The mounting post member preferably has a mount opening for a hollow interior, and the locking post member has a base portion that is adapted to be received through the mount opening and slidably lowered into the hollow interior of the mounting post member.

Preferably, the locking post member includes a key activated lock and first locking protuberance means vertically and horizontally spaced apart from the key activated lock, and the mount opening of the mounting post member includes an inwardly projecting annular collar into which is formed slot means for sequentially receiving through the slot means the first locking protuberance means when vertically aligned with the slot means and then a bolt of the key activated lock when the locking post member has been so rotated that the bolt is vertically aligned with the slot means, the annular collar preventing slidable raising of the locking post member from the mounting post member when the bolt of the key activated lock is received through the slot means, the arrangement being such that a user can slidably lower the base portion of the locking post member into the hollow interior of the mounting post member by vertically aligning the first locking protuberance means with the slot means and then lowering the locking post member so that the first locking protuberance means is positioned vertically below the slot means, and then by rotating the locking post member about its longitudinal axis with respect to the mounting post member so that the first locking protuberance means is no longer positioned vertically below the slot means but is located beneath the annular collar and so that the key activated lock becomes vertically aligned with the slot means, whereupon the user can operate the key activated lock so that the bolt is received through the slot means and the locking post member is thus prevented from further rotation, and the location of the first locking protuberance means beneath the annular collar prevents the locking post member being raised from the mounting post member, thereby lockably engaging the locking post member to the mounting post member.

The locking post member may further include a second locking protuberance means vertically and horizontally spaced apart from the first locking protuberance means and adapted to be received through the slot means before the first locking protuberance means.

Preferably, the locking post member is rotated about its longitudinal axis to an extent necessary to simultaneously lockably secure the rail member thereto when in its second position and vertically align the key activated lock with the slot means.

### BRIEF DESCRIPTION OF THE DRAWINGS

In order that the invention may be readily understood and put into practical effect, reference will now be made to the accompanying drawings, in which:

FIG. 1 is a perspective view of an antitheft locking assembly according to a preferred embodiment of the present invention;

FIG. 2 is a sectional side view of the antitheft locking assembly of FIG. 1;

FIG. 3 is a perspective view of the second post means of the assembly of FIGS. 1 and 2 in which the mounting post member is mounted securably into the ground and to which the locking post member is lockably engaged;

FIG. 4 is a perspective view of the second post means of FIG. 3 in which the base portion of the locking post member is disengaged from the mounting post member (shown removed from the ground) to show the key activated lock, first locking protuberance means and second locking protuberance means of the locking post member, and to show the slot means and annular collar of the mounting post member;

FIG. 5 is a sectional side view of the second post means of FIG. 3; and

FIG. 6 is a side view of a motorbike and the antitheft locking assembly of FIGS. 1 and 2 that is in a locked position to prevent the theft of the motorbike.

### DETAILED DESCRIPTION OF A PREFERRED EMBODIMENT

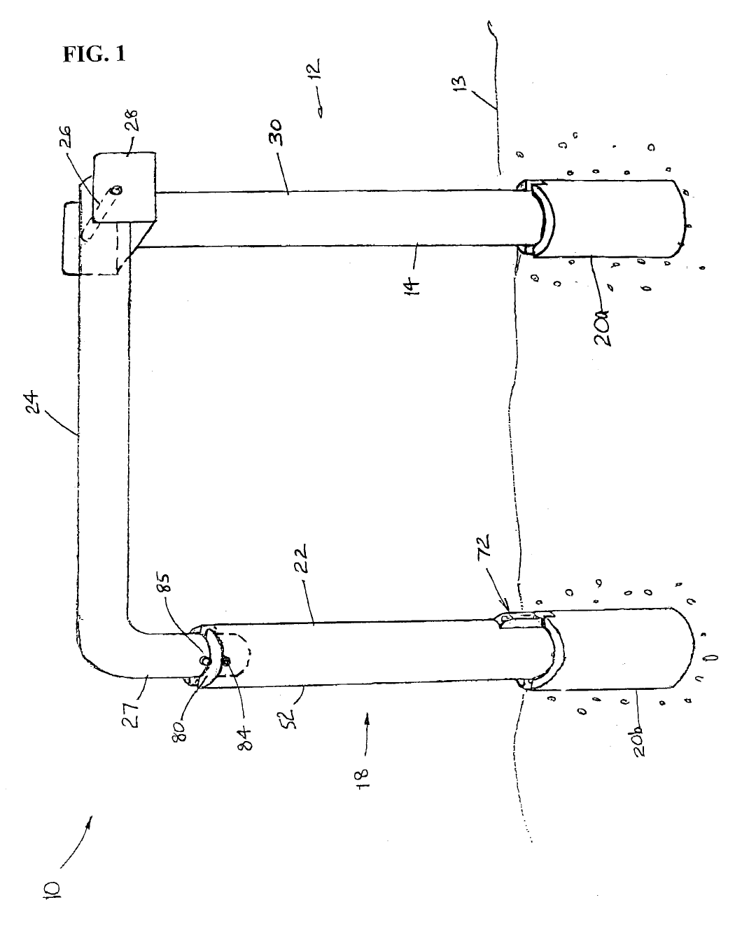

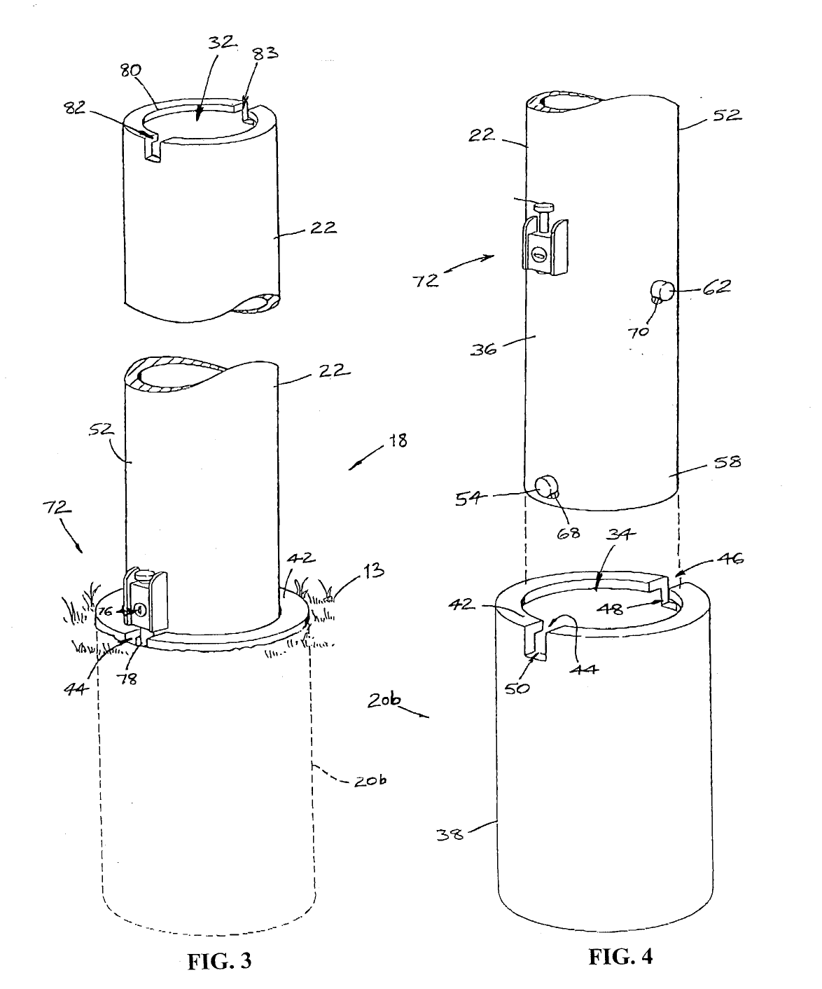

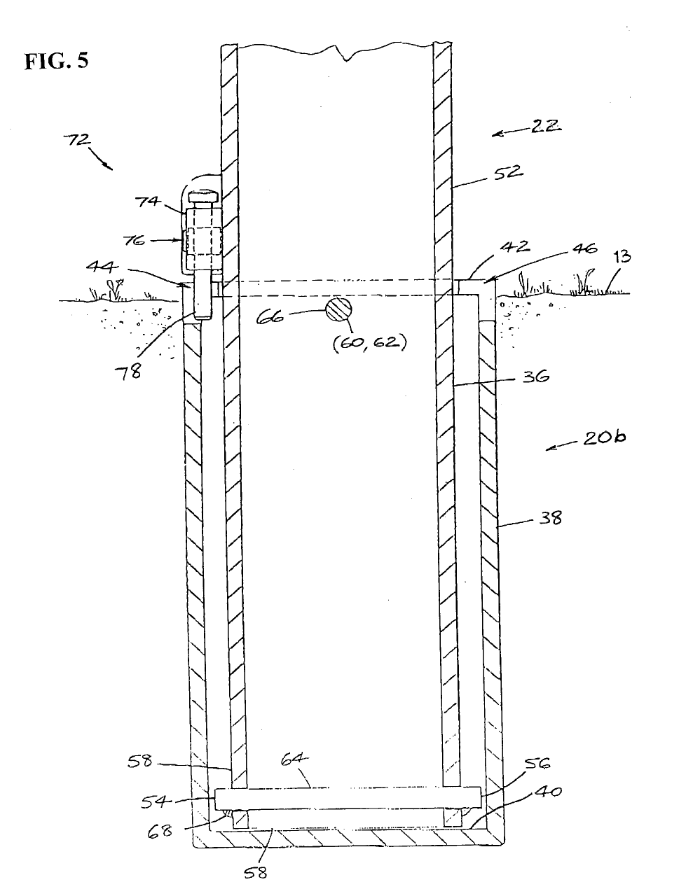

The antitheft rocking assembly 10 shown in FIGS. 1 to 6 has first post 5 means 12 comprising an upright post 14 which is removably anchored in a first mounting post member 20a cemented into the ground 13, and has second post means 18 comprising a second mounting post member 20b cemented into the ground 13 and a locking post member 22 lockably engaged to the second mounting post member 20b and extending upwardly therefrom. The first and second mounting post members 20a, 20b are effectively identical in structure. The first and second post means 12, 18 are spaced apart from each other a sufficient distance to enable a motorbike to be parked there between. There is a rail means 24 that adjustably interconnects the first post means 12 and the locking post member 22. In this embodiment, the rail means 24 has a first end that is pivotally connected to the first post means 12 by a pivot pin 26 so as to allow pivotal movement between a first position where the rail means 24 is pivotally raised to allow access of the motorbike to and from the parked location and a second position where the rail means 24 is pivotally lowered to obstruct access of the motorbike to and from the parked location. The pivot pin 26 is secured at its opposite ends to respective opposed walls of a U-channel bracket 28 that is welded to the top of the cylindrical main body 30 of the upright post 14. The pivot pin 26 passes through holes formed at diametrically opposite sides at the cylindrical first end of the rail means 24. The other end of the rail means 24 is bent perpendicularly downwardly to form a kinked cylindrical portion 27.

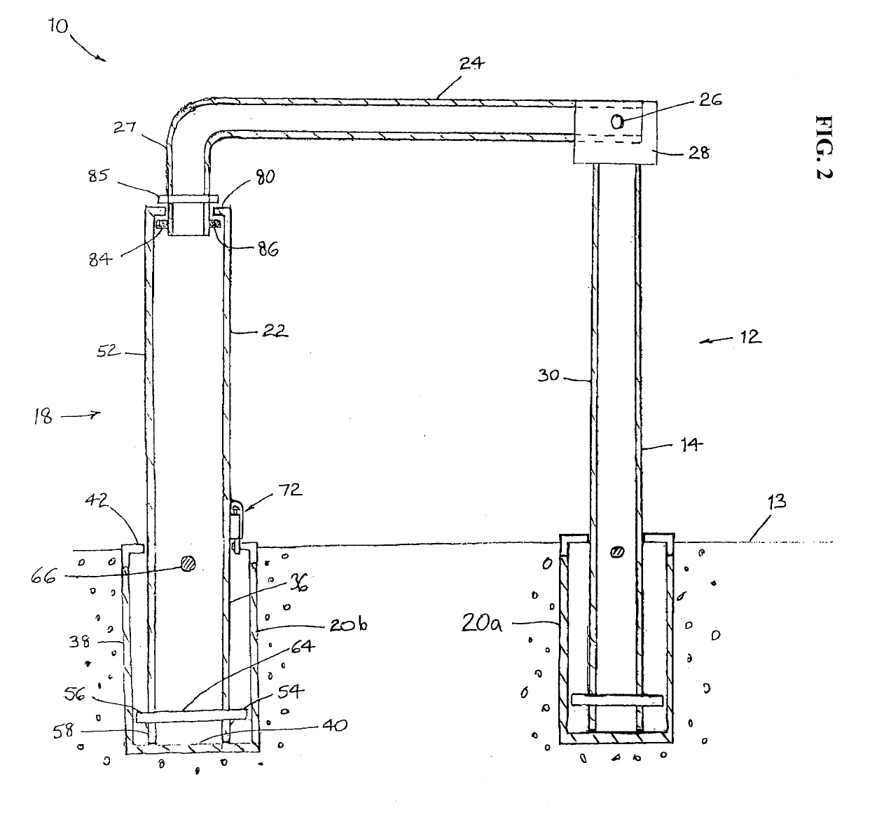

The locking post member 22 has a lock opening 32 extending downwardly from its summit and the free end of the kinked portion 27 is received within the lock opening 32 as shown in FIGS. 1 and 2 when the rail means 24 pivots into its second position where it can be lockably secured.

The locking post member 22 has a longitudinal axis about which it is adapted to be rotated with respect to the mounting post member 20b.

The mounting post member 20b has a mount opening 34 for a hollow interior, and the locking post member 22 has a lock portion 36 that is adapted to be received through the mount opening 34 and slidably lowered into the hollow interior of the mounting post member 20b.

Specifically, the mounting post member 20b consists of a tube shaped vessel 38 with a floor 40 at its lower end and an inwardly projecting annular collar 42 at its upper end defining its mount opening 34. The collar 42 is punctuated by a pair of slots 44, 46 at diametrically opposite positions across the mount opening 34, and portions 48, 50 of the sleeve wall descending from each slot 44, 46 have been cut away.

Specifically, the locking post member 22 has a cylindrically shaped, hollow main body 52, the lock portion 36 of which has a first pair of bosses or rounded protuberances 54, 56 extending axially outwardly therefrom at diametrically opposite positions to each other and adjacent to the base 58 of the locking post member 22. There is a second pair of bosses or rounded protuberances 60, 62 in the lock portion 36 which extend axially outwardly from the locking post member 22 and at diametrically opposite positions to each other, but at a higher position from the base 58 than the protuberances 54, 56. The height of the protuberances 60, 62 from the base 58 of the locking post member 22 is slightly less than the height of the collar 42 from the floor 40 of the mounting post member 20b such that, when the locking post member 22 is properly secured to the mounting post member 20b, the protuberances 60, 62 will fit snugly beneath collar 42. The protuberances 60, 62 are perpendicularly offset from the protuberances 54, 56 so that, when viewed from above, all four protuberances 54, 56, 60, 62 are evenly spaced around the cylindrical main body 52 of the locking post member 22.

Each pair of protuberances 54, 56 and 60, 62 are formed by respective solid metal bars 64, 66 that diametrically span the hollow main body 52 and pass through holes formed therethrough. The bars are secured to the body 52 by welding 68, 70. The cylindrical main body 30 of the upright post 14 has similarly located protuberances for removably anchoring the post 14 in the mounting post member 20a.

There is a lock assembly 72 affixed to the outer surface of the main body 52 of the locking post member 22. The lock assembly 72 includes a lock mechanism housed within a cover 74 that can be operated by the turning of a key engaging a keyhole 76 to reciprocatingly move a pin or bolt 78. The position of the lock assembly 72 on the locking post member 22 is such that, when the locking post member 22 is properly secured to the mounting post member 20b, the bolt 78 is able to be propelled by a first turning of the key into a selected one of the slots 44, 46 so, as to prevent rotation of the locking post member 22 about its longitudinal axis, and the bolt 78 is able to be withdrawn therefrom by a second turning of the key so that the locking post member 22 can rotate freely about its longitudinal axis. In the embodiment shown, the bolt 78 has its line of reciprocating movement aligned with one of the lowermost protuberances 54.

In order to secure the locking post member 22 in an upright position, the mounting post member 20b is first sunk into a pre-excavated hole in the ground 13 and cemented therein so as to provide a stable and secure mounting environment for the second post means 18. The hole is dug only so deep as to ensure that the collar 42 of the mounting post member 20b is flush with or slightly raised from the ground 13.

The locking post member 22 (with the bolt 78 withdrawn) is then held upright over the mounting post member 20b and the lowermost protuberances 54, 56 are aligned vertically with the slots 44, 46. The locking post member 22 is then lowered into the mounting post member 20b so that the protuberances 54, 56 pass through the slots 44, 46 respectively and enter the vessel 38. The locking post member 22 is then rotated 90° about its longitudinal axis so that the uppermost protuberances 60, 62 are aligned vertically over the slots 44, 46. Next, the locking post member 22 is lowered further into the mounting post member 20b so that the protuberances 60, 62 pass through the slots 44, 46 and enter the vessel 38 until the base 58 of the locking post member 22 rests upon the floor 40 of the mounting post member 20b.

At this stage, the rail means 24 is pivoted into its second position so that the free end of the kinked portion 27 is received within the lock opening 32 at the summit of the locking post member 22. The lock opening 32 is defined by an annular collar 80 punctuated by a pair of slots 82, 83 which are of similar structure to those of the mounting post member 20b, and the kinked portion 27 has a pair of opposed protuberances 84, 86 that align vertically with the opposed slots 82, 83 of the annular collar 80 of the lock opening 32. This alignment is the result of the 90° rotation of the locking post member 22 as described earlier. The free end of the kinked portion 27 is pivotally lowered into the locking post member 22 so that the protuberances 84, 86 pass through the slots 82, 83 of the collar 80 of the lock opening 32 and enter the locking post member 22. The protuberances 84, 86, lowered to a position just beneath the slots 82, 83, are prevented from being further lowered by lug means 85 that extends outwardly of the kinked portion 27 to an extent that impacts against the top of the collar 80.

The locking post member 22 is then further rotated about its longitudinal axis sufficiently (usually by a further 90%) so that two locking events may occur. Firstly, the further rotation causes the uppermost protuberances 60, 62 to no longer be aligned beneath the slots 44, 46 and causes the bolt 78, although withdrawn, to have its line of reciprocating movement aligned with one of the slots 44, 46. The bolt 78 of the lock, assembly 72 can now be propelled by a first turning of the key into the slot 44, whereafter the key is removed. Secondly, the further rotation causes, simultaneously, the protuberances 84, 86 to no longer be aligned beneath the slots 82, 83 of the collar 80 of the lock opening 32 but to be moved to positions beneath the collar 80 that will prevent the rail means 24 from being pivotally raised, thereby lockably securing the rail means 24 over the motorbike. Therefore, with the one, say, 90° rotation of the locking post member 22, the locking post member 22 can be lockably engaged to the mounting post member 20b by operation of the key activated lock, and the rail means 24 is lockably secured to the locking post member 22.

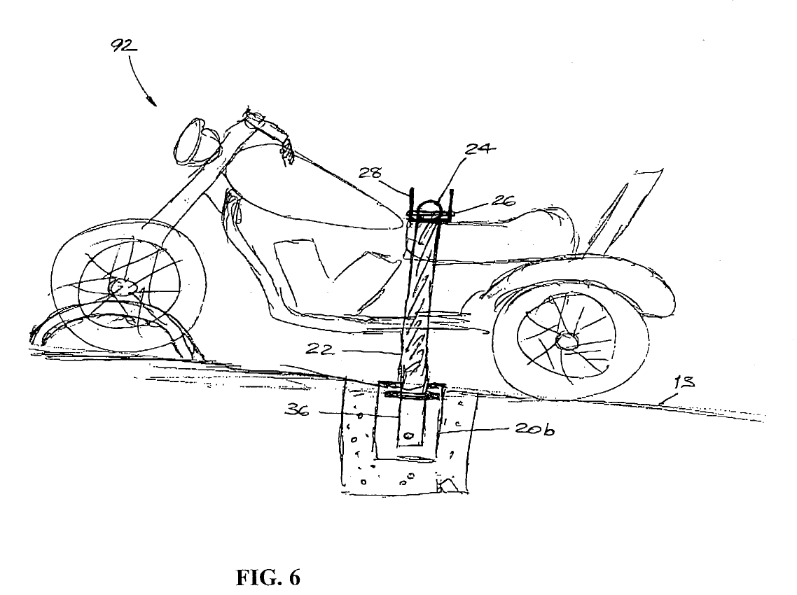

The rail means 24 is now lockably secured in its second position over the motorbike 92 (as shown in FIG. 6) which is parked facing a wall, and no amount of manipulating or tampering with the rail means 24 will detach it from the locking post member 22. Rotating or axial twisting movement of the locking post memb$r 22 is prevented by the engagement of the bolt 78 in the slot 44, and raising or upward movement of the rail means 24 is prevented by the physical engagement of the protuberances 84, 86 against the overlying collar 80 of the lock opening 32.

Various modifications may be made in details of design and construction without departing from the scope or ambit of the invention.

For instance, the upright post 14 may be permanently anchored by directly cementing it into the ground 13. However, by removably anchoring the upright post 14 in a mounting post member 20a which is cemented into the ground 13, as described in detail above, the upright post 14 may be removed when the assembly 10 is not in use.

What we claim is:

1. An antitheft locking assembly for a motorbike comprising first post means adapted to be anchored to the ground or other immobile anchoring medium, second post means spaced apart from the first post means, the second post means comprising a mounting post member adapted to be mounted securably into the ground and a locking post member adapted to be lockably engaged to the, mounting post member and extend upwardly therefrom, rail means adjustably interconnecting the first post means and the locking post member and being movable between a first position where it allows access of the motorbike to and from a parked location in a space between the first post means and the second post means, and a second position where it obstructs access of the motorbike to and from the said parked location, the rail means being lockably secured in its second position over the motorbike so as to prevent the theft of the motorbike.

2. The antitheft locking assembly of claim 1 wherein the rail means has a first end that is pivotally connected to the first post means.

3. The antitheft locking assembly of claim 1 wherein the locking post member has a lock oper!ling, and the rail means has a second end that is adapted to be received within the lock opening.

4. The antitheft locking assembly of claim 3 wherein the lock opening of the locking post member extends downwardly from its summit, and the second end of the rail means projects downwardly so as to be received within the lock opening when the rail means pivots into its second position where it can be lockably secured.

5. The antitheft locking assembly of claim 3 wherein the locking post member has a longitudinal axis about which it is adapted to be rotated with respect to the mounting post member.

6. The antitheft rocking assembly of claim 5 wherein the rail means is lockably secured when in its second position by rotating the locking post member about its longitudinal axis.

7. The antitheft locking assembly of claim 1 wherein the mounting post, member has a mount opening for a hollow interior, and the locking post member has a base portion that is adapted to be received through the mount opening and slidably lowered into the hollow interior of the mounting post member.

8. The antitheft locking assembly of claim 7 wherein the locking post member includes a key activated lock and first locking protuberance means vertically and horizontally spaced apart from the key activated lock, and the mount opening of the mounting post member includes an inwardly projecting annular collar into which is formed slot means for sequentially receiving through the slot means the first rocking protuberance means when vertically aligned with the slot means and then a bolt of the key activated lock when the locking post member has been so rotated that the bolt is vertically aligned with the slot means the annular collar preventing slidable raising of the locking post member from the mounting post member when the bolt of the key activated lock is received through the slot means, the arrangement being such that a user can slidably lower the base portion of the locking post member into the hollow interior of the mounting post member by vertically aligning the first locking protuberance means with the slot means and then lowing the locking post member so that the first locking protuberance means is positioned vertically below the slot means, and then by rotating the locking post member about its longitudinal axis with respect to the mounting post member so that the first locking protuberance means is no longer positioned vertically below the slot means but is located beneath the annular collar and so that the key activated lock becomes vertically aligned with the slot means, whereupon the user can operate the key activated lock so that the bolt is received through the slot means and the locking post member is thus prevented from further rotation, and the location of the first locking protuberance means beneath the annular collar prevents the locking post member being raised from the mounting post member, thereby lockably engaging the locking post member to the mounting post member.

9. The antitheft locking assembly of claim 8 wherein the locking post member further includes a second locking protuberance means vertically and horizontally spaced apart from the first locking protuberance means and adapted to be received through the slot means before the first locking protuberance means.

10. The antitheft locking assembly of claim 8 wherein the locking post member is rotated about its longitudinal axis to an extent necessary to simultaneously lockably secure the rail member thereto when in its second position and vertically align the key activated lock with the slot means.
